(19) United States
(12) Patent Application Publication
(10) Pub. No.: US 2004/0193655 A1
(43) Pub. Date: Sep. 30, 2004

(54) Journal obtaining-distributing apparatus, journal obtaining-distributing method, and program used to direct computer to use method thereof

(75) Inventors: Hisashi Miyata, Kawasaki (JP); Masahiro Suzuki, Kawasaki (JP); Kazuya Oumura, Kawasaki (JP)

Correspondence Address: Patrick G. Burns, Esq., GREER, BURNS & CRAIN, LTD., 300 South Wacker Dr., Suite 2500, Chicago, IL, 60606, US

(73) Assignee: FUJITSU LIMITED

(21) Appl. No.: 10/779,352

(22) Filed: Feb. 13, 2004

(30) Foreign Application Priority Data
Mar. 28, 2003 (JP) 2003-092543

(51) Int. Cl. G06F 12/00

(52) U.S. Cl. 707/200

(57) ABSTRACT

A journal obtaining-distributing apparatus includes a journal obtaining facility and a journal distribution facility, obtains a journal as an update result from a source database, and distributes it to a destination database. The journal obtaining facility obtains the journal from the source database. The journal distribution facility distributes the obtained journal to the destination database for each transaction of updating the source database.

### BACKGROUND OF THE INVENTION

1. Field of the Invention

The present invention relates to the technology of replicating a source database to a destination database, and is appropriately used in copying a database between different platforms.

2. Description of the Related Art

When information in a database occurring in a transaction in which a database is updated in a replicating operation, it is necessary to obtain the data (hereinafter referred to as a journal) updated in the transaction from a source database, and distribute it to a destination database.

Described below is a journal obtaining-distributing system according to the conventional technology for obtaining a journal from a source database, and distributing the journal to a destination database. FIG. 1 shows the configuration of a journal obtaining-distributing system according to the conventional technology.

The journal obtaining-distributing system shown in FIG. 1 has a computer C1 and a computer C2. First, the configuration of the computer C1 is explained. The computer C1 includes a source database DBa and a source database DBb, and these source databases are managed by a database management system (hereinafter referred to as a DBMS) 101. Furthermore, the computer C1 includes a journal obtaining facility 102, a journal obtaining file 103, and a journal distribution facility 104. The journal obtaining file 103 is provided for a source database. In the case shown in FIG. 1, journal obtaining files 103a and 103b are provided respectively for the source databases DBa and DBb.

The DBMS 101 outputs a trigger to the journal obtaining facility 102 when the source databases DBa and DBb are updated by a transaction.

The journal obtaining facility 102 is called by the trigger output by the DBMS 101. The journal obtaining facility 102 obtains journals separately from the source databases DBa and DBb, and writes the journals to the journal obtaining files 103a and 103b respectively. The journal distribution facility 104 distributes the journals written to the journal obtaining files 103a and 103b to the computer C2 having a destination database.

Described below is the configuration of the computer C2. The computer C2 includes the destination databases DB1 and DB2, and the journal-using files 201a and 201b storing a distributed journal. The journal-using files 201a and 201b respectively correspond to the journal obtaining files 103a and 103b. The journal distribution facility 104 in the computer C1 arranges the journals written to the journal obtaining file 103a in the order in which they have been updated, puts them in a file, and collectively writes them to the journal-using file 201a. Similarly, the journal distribution facility 104 writes the journal written to the journal obtaining file 103b to the journal-using file 201b.

If the journals have been written to the journal-using files 201a and 201b, the journals are replicated in a distribution unit to the destination databases DB1 and DB2. Replicating a journal to a destination database is referred to as reflecting a journal.

Then, the communications of a journal in the system shown in FIG. 1 is described by referring to FIG. 2. FIG. 2 shows a flow of the process of communicating a journal when the column 1 of the source database DBa and the column 1 of the source database DBb are updated in a transaction T1, and the column 2 of the source database DBa and the column 2 of the source database DBb are updated in a transaction T2.

When the source databases DBa and DBb are updated in the transactions T1 and T2, a trigger calls the journal obtaining facility 102. The journal obtaining facility 102 obtains journals from the columns 1 and 2 in the source database DBa, and writes them to the journal obtaining file 103a. Similarly, the journal obtaining facility 102 obtains journals from the columns 1 and 2 in the source database DBb, and writes them to the journal obtaining files 103b.

The journal distribution facility 104 obtains the journals in the columns 1 and 2 in the source database DBa from the journal obtaining file 103a, puts them in a file in the order in which they have been updated, and collectively writes them to the journal-using file 201a. Similarly, the journal distribution facility 104 obtains the journals in the columns 1 and 2 in the source database DBb from the journal obtaining file 103b, puts them in a file in the order in which they have been updated, and collectively writes them to the journal-using file 201b.

Then, a transaction T3, in which the journals in the columns 1 and 2 in the source database DBa are reflected in the destination database DB1, is performed on the journal-using file 201a. Similarly, a transaction T4, in which the journals in the columns 1 and 2 in the source database DBb are reflected in the destination database DB2, is performed on the journal-using file 201b.

In the above-mentioned series of processes, the update result of the source databases DBa and DBb by the transactions are reflected in the destination databases DB1 and DB2 by describing, for example, “Instructions of FUJITSU Linkexpress Replication option”, [online], [retrieved on Feb. 12, 2003], Internet, <URL:http://software.fujitsu.com/jp/manual/s/d23pdp 4ha/j2x03641/01/>.

In the above-mentioned conventional technology, when a plurality of source databases are replicated, journals are obtained from each source database (or in a source database unit), and the obtained journals are distributed to the journal-using file provided for each source database. However, when a plurality of source databases are updated in a transaction, the state in which an update result of a source database is reflected in a destination database but not yet in other destination databases in a replicating process can temporarily occur. For example, in an example shown in FIG. 2, the transaction T1 updates the source databases DBa and DBb. In the transactions T3 and T4, the journals generated by the update are reflected in destination databases. During the reflection, the state in which the transaction T3 has been performed but the transaction T4 has not been performed, that is, the state in which the reflection in the destination database DB1 has been performed but the reflection in the destination database DB2 has not been performed, can temporarily occur.

Assume that a new transaction is to be performed by referring to a destination database in the above-mentioned state. Since the result of the transaction of updating a source database has not been completely reflected, there arises the problem that it is difficult to transfer control to a new transaction.

Therefore, according to the conventional technology, the consistency among databases can be maintained and control can be transferred to a new transaction in the following method. The first method is described below. In the first method, when an application of using a plurality of databases is carried out, an update date and time are input to a record when a database is updated so that the consistency can be maintained among a plurality of databases based on the update date and time.

The procedure of the first method is described below in detail by referring to FIG. 3. In FIG. 3, as in FIG. 2, it is assumed that the column 1 of the source database DBa and the column 1 of the source database DBb are updated in the transaction T1, and the column 2 of the source database DBa and the column 2 of the source database DBb are updated in the transaction T2. When the columns are updated, an update date and time are added to each record. After a journal is obtained and distributed by referring to FIG. 2, the transaction T3 of reflecting a journal in the columns 1 and 2 of the destination database DB1, and the transaction T4 of reflecting a journal in the columns 1 and 2 of the destination database DB2 are performed. Furthermore, assume that a new transaction T5 of referring to the column 1 of the destination database DB1 and the column 1 of the destination database DB2 is performed. In this case, in the first method, the update date and time added to the record in each referenced column is compared in the transaction T5. Therefore, for example, if the transaction T5 is performed in the state in which the transaction T3 has been performed while the transaction T4 has not been performed, then the consistency of data between the destination databases DB1 and DB2 cannot be maintained, and the transaction T5 is canceled.

However, there has been the problem with the first method that the logical process required to confirm the consistency between databases based on the update date and time is complicated.

Described below is the second method of maintaining the consistency between databases. In the first method, a journal is reflected in one database. In the second method, a journal is reflected in a plurality of databases in one transaction. For example, in an example of the case described by referring to FIG. 3, the processes performed in the transactions T3 and T4 in the first method are collectively performed in a transaction T6 in the second method. Therefore, in the second method, the complicated logical process used in the first method is not required.

The procedure of the second method is described in detail by referring to FIG. 4. In FIG. 4, as in FIGS. 2 and 3, the transactions T1 and T2 of updating a plurality of databases are assumed. In the second method, after journals are obtained and distributed as described above by referring to FIG. 2, the transaction T6 of collectively reflecting journals in the destination databases DB1 and DB2 is performed. Furthermore, assume that a new transaction T7 of referring to the columns updated in the destination databases DB1 and DB2 is performed. Since the destination databases DB1 and DB2 cannot be referred to by exclusive control, the transaction T7 cannot be completed during the reflecting process in the transaction T6. Therefore, in the second method, the consistency between databases can be maintained.

However, since journals are collectively reflected in the second method, it takes a long time to perform a reflecting process when a large amount of journals are reflected. Since a destination database cannot be referred to during the process, there arises a delay in the transaction processing time in which a destination database is referred to, or the transaction possibly terminates abnormally because of timeout in the worst case.

### SUMMARY OF THE INVENTION

To solve the above-mentioned problems, the present invention aims at providing the replicating technology for maintaining the consistency between databases while avoiding a complicated logical process or a delay of transaction processing time.

To solve the above-mentioned problem, according to an aspect of the present invention, a journal obtaining-distributing apparatus which obtains a journal as an update result from a source database, and distributes the journal to a destination database includes: a journal obtaining unit for obtaining the journal; and a journal distribution unit for distributing the obtained journal to the destination database in a transaction unit in which the source database is updated.

The journal obtaining unit obtains a journal from a source database, and the journal distribution unit distributes a journal in a transaction unit. Conventionally, when a plurality of source databases are replicated, journals are distributed in a source database unit. However, according to an aspect of the present invention, the consistency of databases is maintained by distributing journals in a transaction unit. Thus, the complicated logical process performed in the first method is not required, and a delay of a transaction processing time, which occurs in the second method, can be avoided.

The above-mentioned journal obtaining-distributing apparatus can further include a transaction identification information acquisition unit for acquiring transaction identification information for identifying a transaction of updating the source database when the journal is obtained, and the journal distribution unit can distribute the journal in a transaction unit according to the transaction identification information.

The journal obtaining-distributing apparatus can have a different configuration depending on the receipt of a notification that a transaction has been committed from a source database. Described first is the configuration for a case in which a notification of the commission has not been received.

In this case, the journal obtaining-distributing apparatus can further include a DB update counter unit for counting the number of times the source database is updated, and the journal obtaining unit can rearrange the journals according to the count value and the transaction identification information before distributing a journal.

Furthermore, the journal obtaining-distributing apparatus can further include: a journal management information storage unit for storing the count value and the transaction identification information obtained when the count value is obtained with the count value associated with the information; and a journal storage unit for storing the journal and the transaction identification information obtained when the journal is obtained with the journal associated with the information. At a predetermined timing, the journal distribution unit can obtain the transaction identification information associated with the smallest count value from the journal management information storage unit, and can select the journal corresponding to the transaction identification information obtained from the journal management information storage unit in the journals stored in the journal storage unit as a journal to be distributed.

Described below is the configuration for a case in which a notification of the commission has been received. In this case, the journal obtaining unit in the journal obtaining-distributing apparatus can receive a notification that a transaction of updating the source database has been committed, and can use journals in a transaction unit according to the notification and the transaction identification information about the commitomted transaction.

In this case, the journal obtaining-distributing apparatus can further include a journal temporary storage unit for storing the journal associated with the transaction identification information obtained when the journal is obtained, and the journal obtaining unit can select the journal associated with the transaction identification information about the committed transaction in the journal temporary storage unit according to the notification as a journal to be distributed. Furthermore, the journal obtaining-distributing apparatus can further include a journal storage unit for storing the selected journal, and the journal distribution unit can read and distribute a journal from the journal storage unit at a predetermined timing in the order in which the journals were stored.

In the journal obtaining-distributing method formed by the procedures similar to the operations performed by the journal obtaining-distributing apparatus, the operations and effects similar to those obtained by the journal obtaining-distributing apparatus can be obtained, thereby solving the above-mentioned problems.

Furthermore, the computer program used to direct a computer to perform the procedures in the journal obtaining-distributing method can also temporarily be stored in the memory of the computer and direct the computer to read the computer program from the memory and execute the program, thereby solving the above-mentioned problems.

Additionally, the above-mentioned problems can be solved by directing the computer to read the program from a computer-readable storage medium storing the computer program and execute it.

### BRIEF DESCRIPTION OF THE DRAWINGS

FIG. 1 shows the configuration of the journal obtaining-distributing apparatus according to the conventional technology;

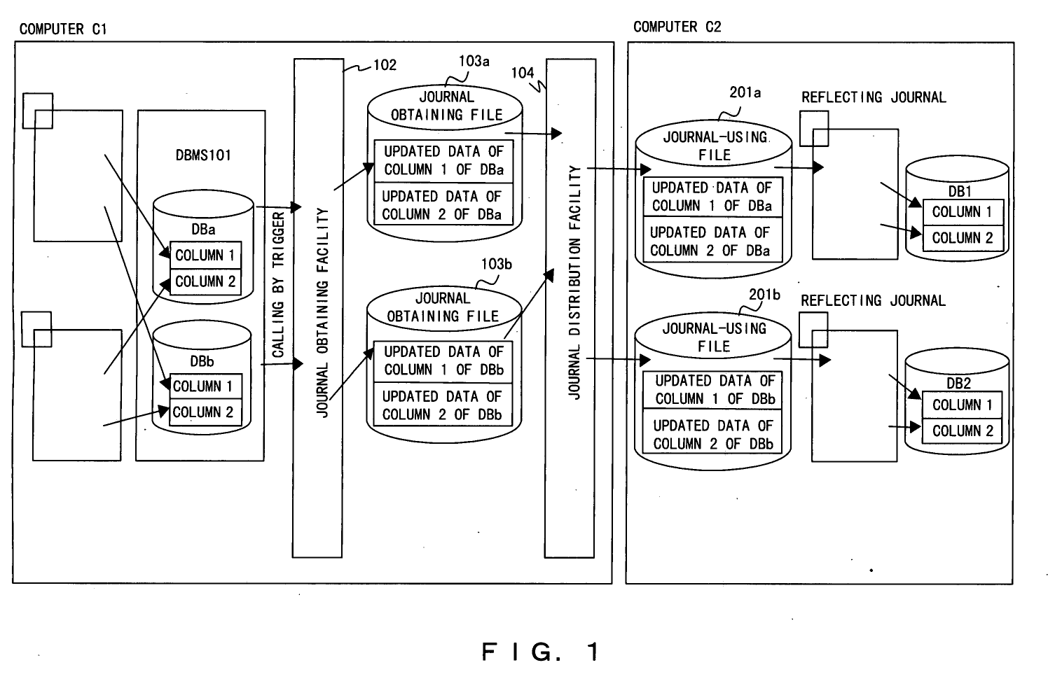

FIG. 2 shows the outline of the flow of communicating a journal in the journal obtaining-distributing system according to the conventional technology;

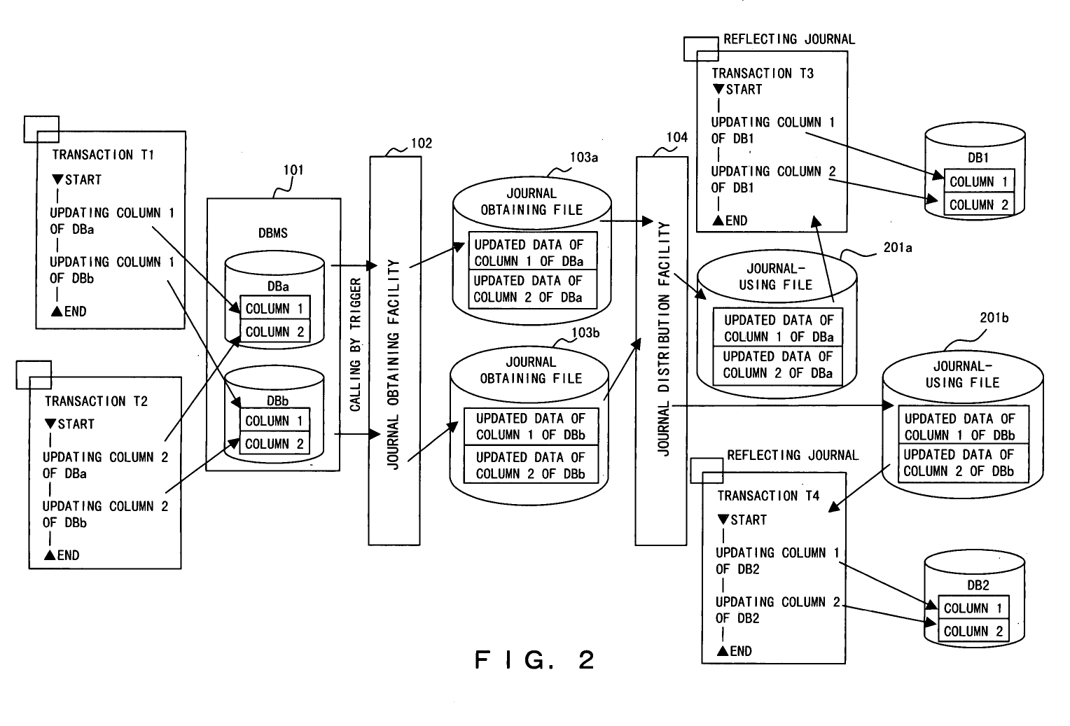

FIG. 3 is an explanatory view (1) of the problem with the journal obtaining-distributing system according to the conventional technology;

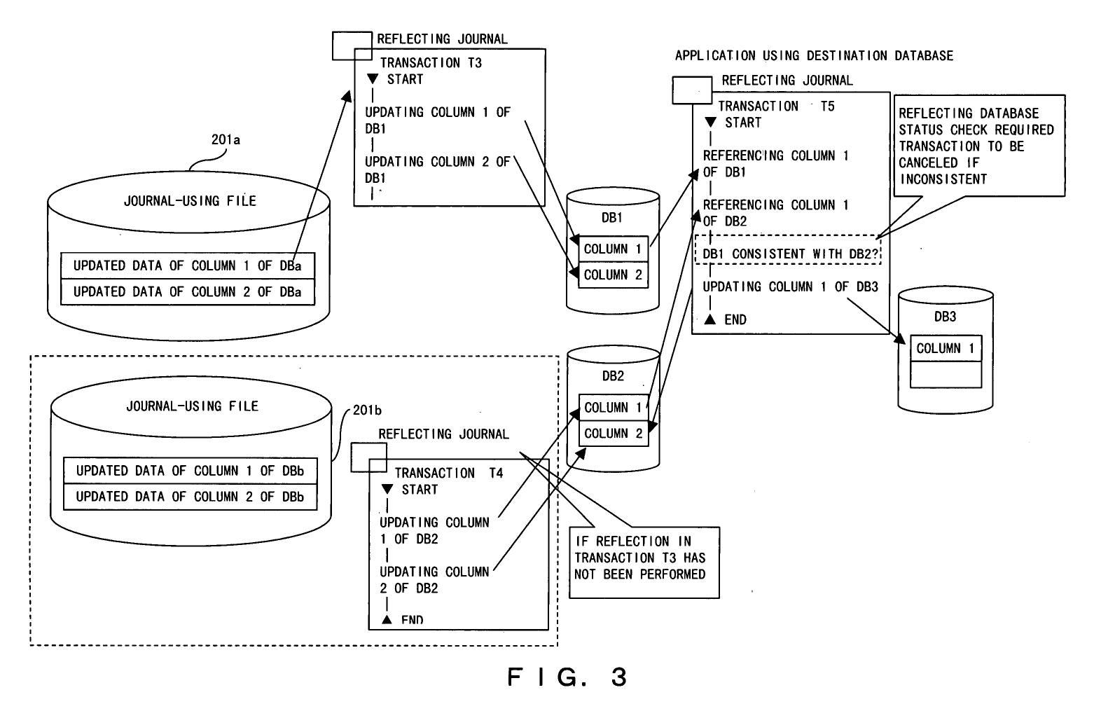

FIG. 4 is an explanatory view (2) of the problem with the journal obtaining-distributing system according to the conventional technology;

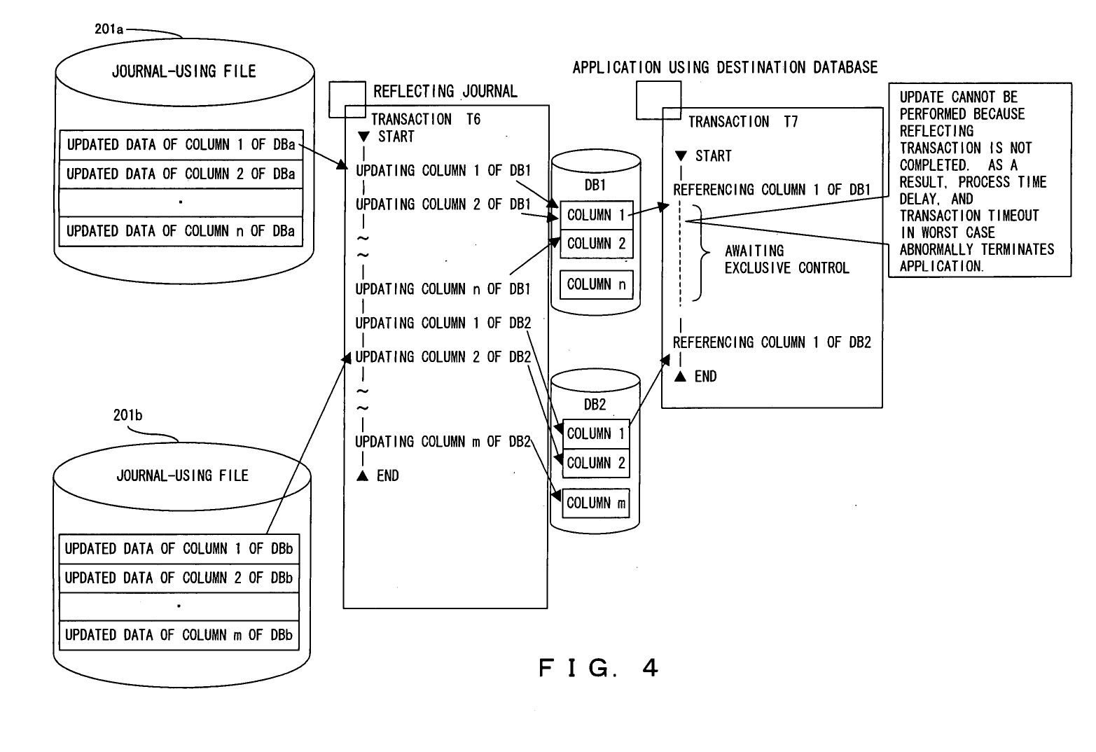

FIG. 5 shows the configuration of the journal obtaining-distributing apparatus according to the first embodiment of the present invention;

FIG. 6 shows an example of the data structure of a journal management table;

FIG. 7 shows an example of the data structure of a journal storage table;

FIG. 8 shows the configuration of the journal obtaining-distributing system according to the first embodiment of the present invention;

FIG. 9 is an explanatory view of the outline of the flow of the communications of a journal in the journal obtaining-distributing system according to the first embodiment of the present invention;

FIG. 10 is a flowchart of the journal obtaining process according to the first embodiment of the present invention;

FIG. 11 is an explanatory view (1) of a practical journal obtaining process according to the first embodiment of the present invention;

FIG. 12 is an explanatory view (2) of a practical journal obtaining process according to the first embodiment of the present invention;

FIG. 13 is an explanatory view (3) of a practical journal obtaining process according to the first embodiment of the present invention;

FIG. 14 is a flowchart of the journal distributing process;

FIG. 15 is a practical explanatory view of the journal distributing process;

FIG. 16 shows the configuration of the journal obtaining-distributing apparatus according to the second embodiment of the present invention;

FIG. 17 shows an example of the data structure of journal storage area;

FIG. 18 is an explanatory view of the outline of the flow of communicating a journal in the journal obtaining-distributing system according to the second embodiment of the present invention;

FIG. 19 is a flowchart (1) of the journal obtaining process according to the second embodiment of the present invention;

FIG. 20 is a flowchart (2) of the journal obtaining process according to the second embodiment of the present invention;

FIG. 21 is a flowchart of the journal distributing process according to the second embodiment of the present invention;

FIG. 22 shows an example of an application of the journal obtaining-distributing apparatus;

FIG. 23 shows the configuration of a computer; and

FIG. 24 is an explanatory view of loading data and a program into a computer.

### DESCRIPTION OF THE PREFERRED EMBODIMENTS

The embodiments of the present invention are described below by referring to the attached drawings. The devices, etc. commonly shown in the attached drawings are assigned the same reference numerals and the overlapping explanation is omitted.

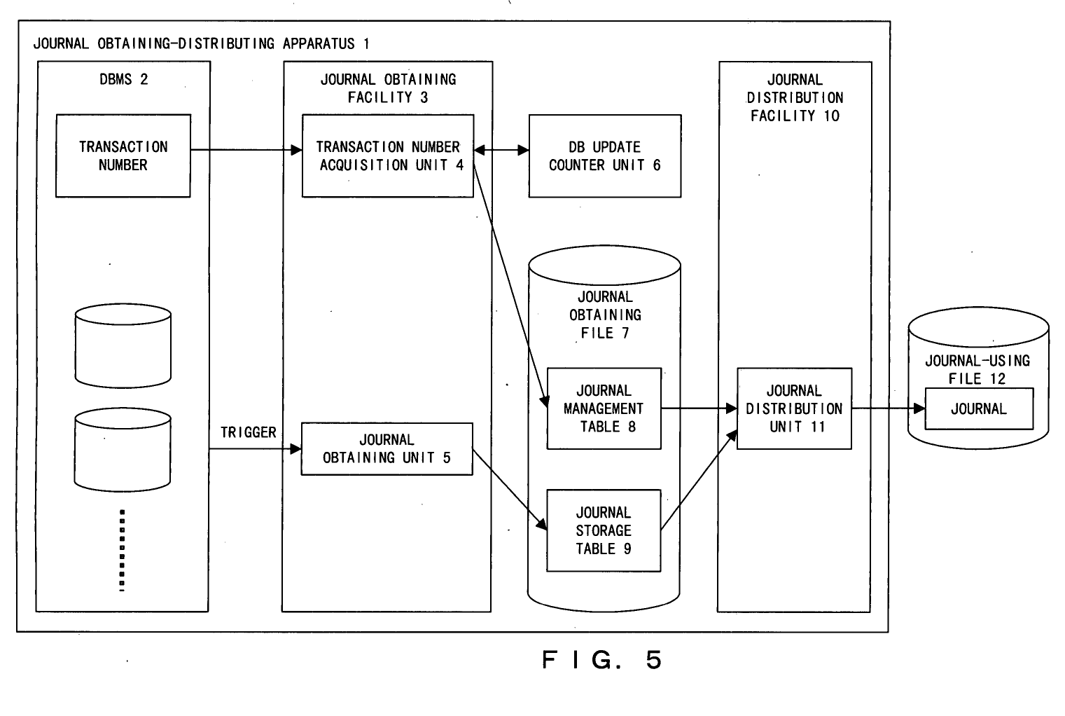

FIG. 5 shows the configuration of the journal obtaining-distributing apparatus according to the first embodiment of the present invention. As shown in FIG. 5, a journal obtaining-distributing apparatus 1 comprises a DBMS 2, a journal obtaining facility 3, a DB update counter unit 6, a journal obtaining file 7, and a journal distribution facility 10. Destination databases (not shown in the attached drawings) equal in number to source databases are provided at the destination of journals. Although it is assumed that two source databases DBa and DBb are provided in each figure and description, it is assumed for simple explanation only, and two or more source databases can be provided.

The DBMS 2 manages a plurality of source databases DBa and DBb. The DBMS 2 calls the journal obtaining facility 3 by a trigger when the source databases DBa and DBb are updated in a transaction. The DBMS 2 also uniquely assigns to each transaction a transaction number for identifying a transaction for each process of updating a database.

The journal obtaining facility 3 obtains a transaction number and a journal from the DBMS 2 when it is called from the DBMS 2, and writes them collectively to the journal obtaining file 7 for each transaction. The journal obtaining file 7 associates a journal with its transaction number, and stores the journal. Described below in detail are the configurations of the journal obtaining facility 3 and the journal obtaining file 7.

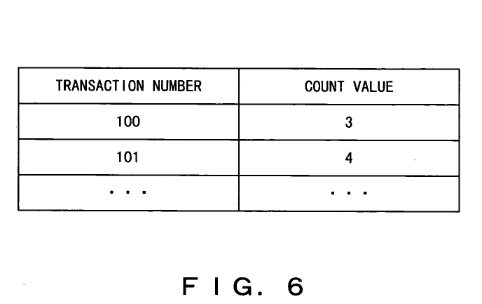

As shown in FIG. 5, the journal obtaining facility 3 comprises a transaction number acquisition unit 4 and a journal obtaining unit 5. The journal obtaining file 7 also comprises a journal management table 8 and a journal storage table 9. The transaction number acquisition unit 4 acquires a transaction number from the DBMS 2. Furthermore, the transaction number acquisition unit 4 increments the DB update counter unit 6 by 1, and then acquires the count value. The transaction number acquisition unit 4 then writes the transaction number and the latest count value acquired when the transaction number is obtained to the journal management table 8. FIG. 6 shows an example of the data structure of the journal management table 8. As shown in FIG. 6, the record in the journal management table 8 includes a transaction number and a corresponding count value. When a new transaction number is obtained, a record is added to the journal management table 8. Each time the DB update counter unit 6 is incremented, the record in the journal management table 8 is updated or a new record is inserted into the journal management table 8.

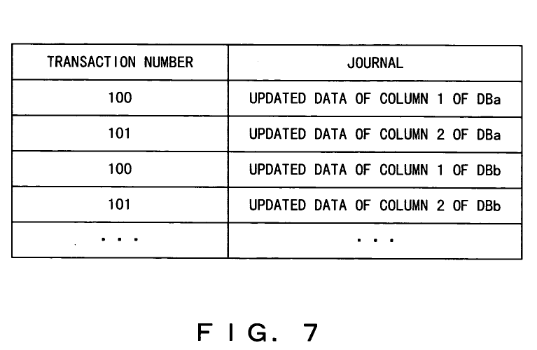

The journal obtaining unit 5 obtains a journal from the source database, and writes the obtained journal to the journal storage table 9 together with the transaction number acquired when the journal is obtained. FIG. 7 shows an example of the data structure of the journal storage table 9. As shown in FIG. 7, the record in the journal storage table 9 includes a transaction number and a corresponding journal. When a new journal is obtained, a record is added to the journal storage table 9.

According to the present invention, a journal is distributed for each transaction on a journal obtaining side. Therefore, it is not necessary to provide the journal obtaining file 7 corresponding to a source database.

The DB update counter unit 6 is unique in the journal obtaining-distributing apparatus, and is incremented each time a database is updated. The DB update counter unit 6 is arranged on, for example, the memory provided for a computer for realizing the journal obtaining-distributing apparatus 1.

The journal distribution facility 10 distributes a journal to the destination databases DB1 and DB2 through a journal-using file 12. The journal distribution facility 10 is provided with a journal distribution unit 11. The journal distribution unit 11 reads a journal from the journal storage table 9 for each performed transaction in which a source database is updated and writes the journal to the journal-using file 12, referring to the journal management table 8. The journal written to the journal-using file 12 is written to the destination databases DB1 and DB2 in the transaction for reflecting the journal. A journal is reflected for each transaction when a source database is updated (that is, the transaction on a journal obtaining side).

The journal-using file 12 stores a distributed journal. In the conventional technology, a journal is distributed for each source database. Therefore, a journal-using file is provided corresponding to a source database. According to the present invention, a journal is distributed for each transaction on a journal obtaining side. Therefore, it is not necessary to provide the journal-using file 12 for each source database.

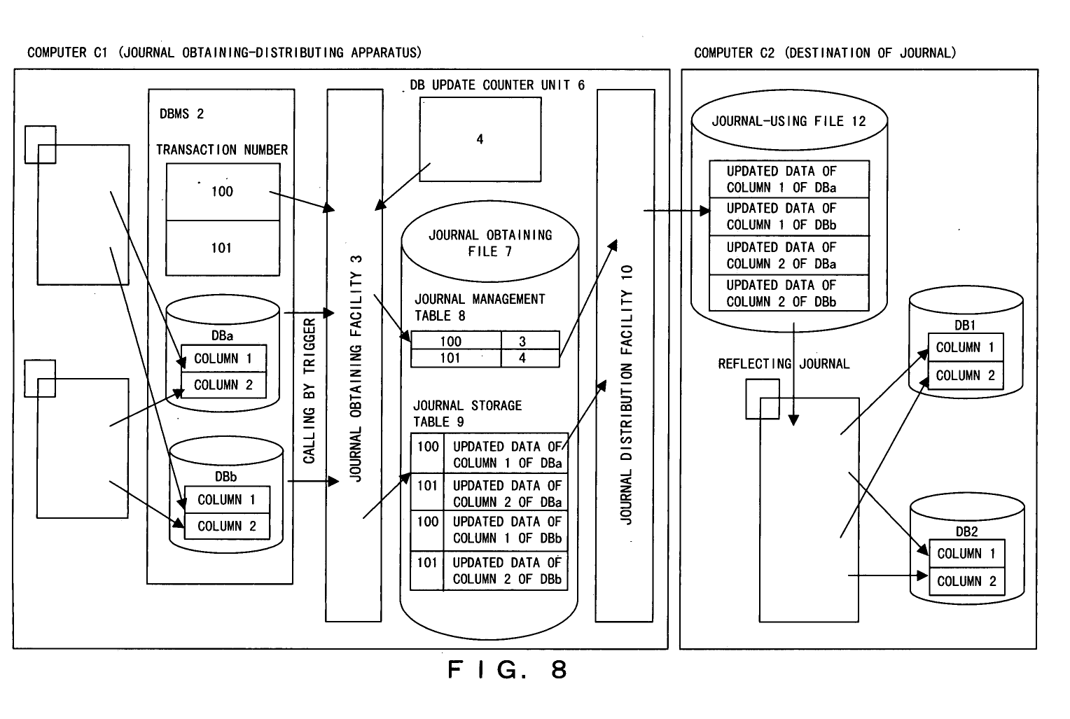

The configuration of the system to which the journal obtaining-distributing apparatus is applied is described below by referring to FIG. 8. As shown in FIG. 8, the computers C1 and C2 are connected in the journal obtaining-distributing system through a network .

The computer C1 comprises source databases DBa and DBb, the DBMS 2 for managing the source databases, the journal obtaining facility 3, the DB update counter unit 6, the journal obtaining file 7, and the journal distribution facility 10. The computer C1 corresponds to the journal obtaining-distributing apparatus 1. The computer C2 comprises the journal-using file 12, and the destination databases DB1 and DB2.

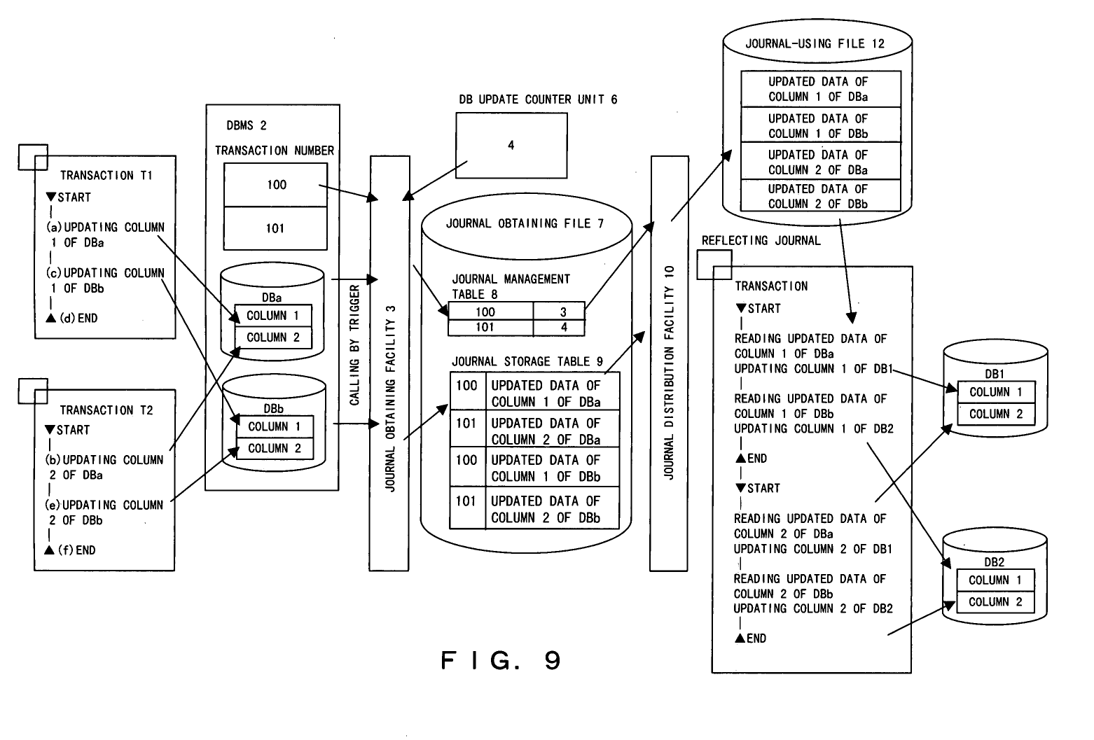

Described below is the procedure of the journal acquiring and distributing process according to the first embodiment of the present invention. The flow of the communications of a journal in the journal obtaining-distributing system shown in FIG. 8 is described below by referring to FIG. 9. First, in the transactions T1 and T2, the source databases DBa and DBb are updated. The processes performed in the order from (a) to (f) in the transactions T1 and T2 are listed as follows.

(a) Updating the column 1 of the source database DBa in the transaction T1

(b) Updating the column 2 of the source database DBa in the transaction T2

(c) Updating the column 1 of the source database DBb in the transaction T1

(d) Terminating the transaction T1 (commission), and guaranteeing the contents of the database

(e) Updating the column 2 of the source database DBb in the transaction T2

(f) Terminating the transaction T2 (commission), and guaranteeing the contents of the database

Each time a database is updated, the journal obtaining facility 3 is called by a trigger from the DBMS 2. The journal obtaining facility 3 obtains a journal and a transaction number from the DBMS 2 each time it is called, and obtains a count value from the DB update counter unit 6. Then, the journal obtaining facility 3 writes the obtained count value and transaction number to the journal management table 8, and writes the journal and the transaction number to the journal storage table 9.

The DB update counter unit 6 is incremented by 1 each time a database is updated. Therefore, assuming that the count value of the DB update counter unit 6 is 0 when the transaction T1 starts, the count values that are to be obtained when the updating processes (a), (b), (c), and (e) are performed are respectively 1, 2, 3, and 4. Since the process (c) is the last process in the transaction T1, the final count value corresponding to the transaction number “100” in the journal management table 8 is 3 if the transaction number of the transaction T1 is assumed to be 100. Similarly, since the process (e) is the last process in the transaction T2, the final count value corresponding to the transaction number “101” in the journal management table 8 is 4 if the transaction number of the transaction T2 is assumed to be 101.

The journal distribution facility 10 obtains a transaction number from the journal management table 8, retrieves a journal associated with the transaction number from the journal storage table 9, and distributes it to the journal-using file 12. If a plurality of transaction numbers are stored in the journal management table 8, the process is performed in the ascending order from the transaction number corresponding to the smallest count value. For example, in the case of the journal obtaining file 7 shown in FIG. 9, the transaction number corresponding to the smallest count value of 3 in the journal management table 8 is 100. Therefore, the journals “update data of the column 1 of DBa” and “update data of the column 1 of DBb” associated with the transaction number “100” in the journal storage table 9 are first distributed to the journal-using file 12. Then, the journals generated by the transaction having the transaction number “101” corresponding to the count value of 4, that is, “update data of the column 2 of DBa” and “update data of the column 2 of DBb”, are distributed to the journal-using file 12. Thus, the journals are distributed for each transaction on the journal obtaining side.

When a journal is distributed to the journal-using file 12, the journal is reflected in the computer C2. Since the journal is distributed for each transaction on the journal obtaining side, the journal is reflected for each transaction on the journal obtaining side. In the case shown in FIG. 9, the transaction reflecting a journal is divided into two portions. The former half reads “update data of the column 1 of DBa” from the journal-using file 12, updates the destination database DB1, further reads “update data of the column 1 of DBb”, and updates the destination database DB2. The latter half reads “update data of the column 2 of DBa” from the journal-using file 12, updates the destination database DB1, further reads “update data of the column 2 of DBb” and updates the destination database DB2.

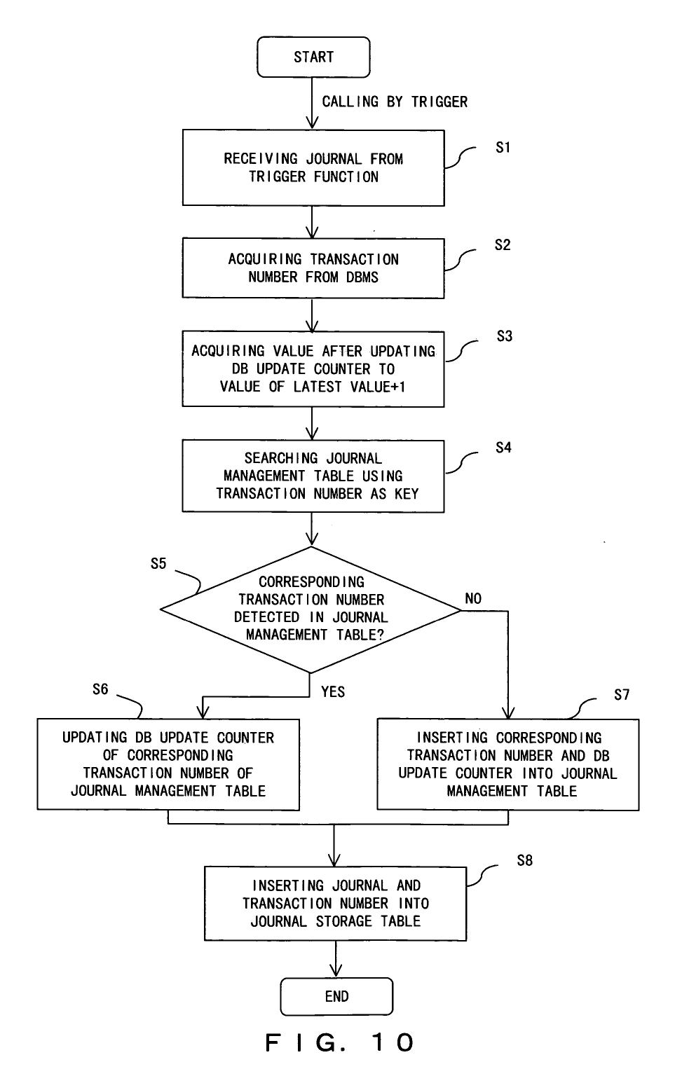

The journal obtaining-distributing process according to the first embodiment is described in detail by referring to FIGS. 10 through 15. The journal obtaining process is described first by referring to FIGS. 10 through 13. In the journal obtaining process, the journal obtaining facility 3 obtains a journal from a source database. FIG. 10 is a flowchart showing the journal obtaining process. The process shown in FIG. 10 is performed each time the journal obtaining facility 3 is called by a trigger from the DBMS 2.

As shown in FIG. 10, when the journal obtaining facility 3 is called by a trigger from the DBMS 2, the journal obtaining unit 5 receives a journal from the DBMS 2 (step S1). Then, the transaction number acquisition unit 4 acquires a transaction number from the DBMS 2 (step S2). The transaction number acquisition unit 4 also increments by 1 the count value of the DB update counter unit 6, and acquires the count value (step S3). The transaction number acquisition unit 4 searches the journal management table 8 using the acquired transaction number as a key (step S4), and determines whether or not a record having the transaction number is stored in the journal management table 8 (step S5).

When the record having the transaction number is stored in the journal management table 8 (YES in step S5), the transaction number acquisition unit 4 updates the count value contained in the record into the count value acquired in step S3 (step S6), and control is passed to step S8. If no record having the transaction number is stored in the journal management table 8 (NO in step S5), then the transaction number acquisition unit 4 inserts the transaction number and the record having the count value acquired in step S3 into the journal management table 8 (step S7), and control is passed to step S8. In step S8, the journal obtaining unit 5 inserts the journal obtained in step S1 and the record having the transaction number acquired in step S2 into the journal storage table 9, thereby terminating the process.

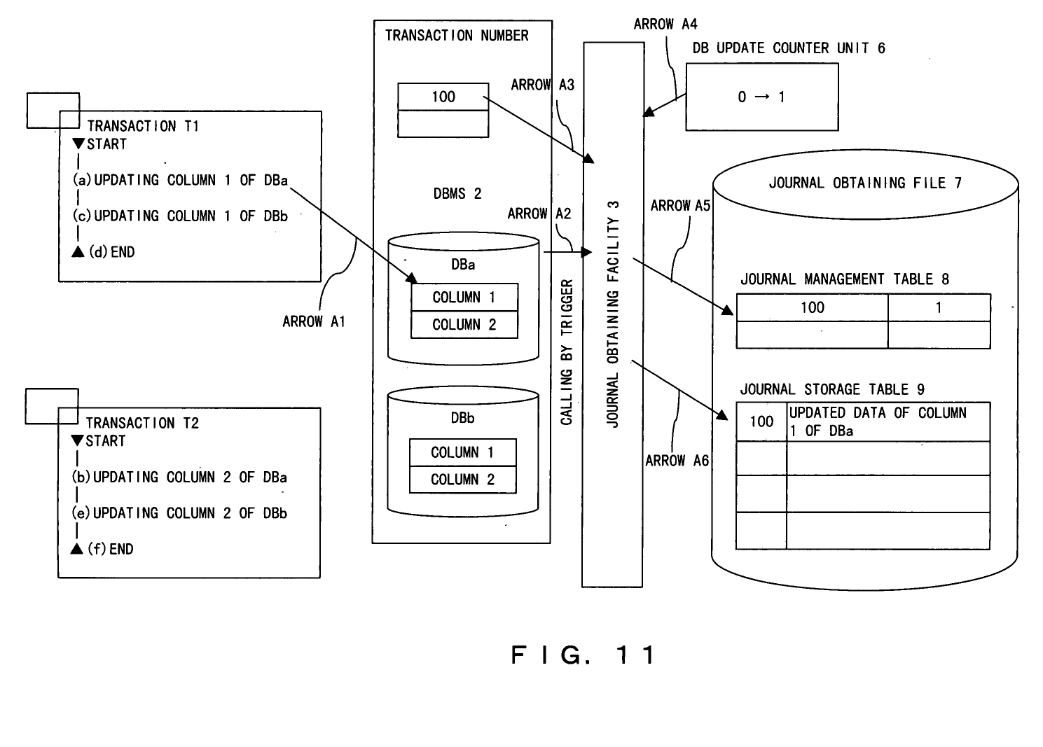

The above-mentioned journal obtaining process is practically explained below by referring to FIGS. 11 through 13. In the explanation, the same assumption as in explaining the communications of a journal by referring to FIG. 9 is used for easy explanation.

The journal obtaining process to be performed when the updating process (a) in the transaction T1 is performed is explained first by referring to FIG. 11. When the column 1 of the source database DBa is updated in the updating process (a) in the transaction T1 (arrow A1), the journal obtaining facility 3 is called by a trigger from the DBMS 2 (arrow A2). The journal obtaining facility 3 acquires the transaction number “100” of the transaction T1 from the DBMS 2 (arrow A3). Furthermore, the journal obtaining facility 3 increments by 1 the count value of 0 in the DB update counter unit 6, and obtains the count value of 1 (arrow A4). The journal obtaining facility 3 inserts a record containing the transaction number “100” and the count value of 1 into the journal management table 8 (arrow A5), and inserts a record containing the transaction number “101” and “updated data of the column 2 of the source database DBa” into the journal storage table 9 (arrow A6).

Then, the journal obtaining process occurring from the updating process (b) in the transaction T2 is performed. This process is the same as that described above, and the explanation is omitted here. In this case, the transaction number “101” is acquired, and the count value of 2 is obtained. As a result, a record containing the transaction number “101” and the count value of 2 is inserted into the journal management table 8, and a record containing the transaction number “101” and “updated data of the column 2 of the source database DBa” is inserted into the journal storage table 9.

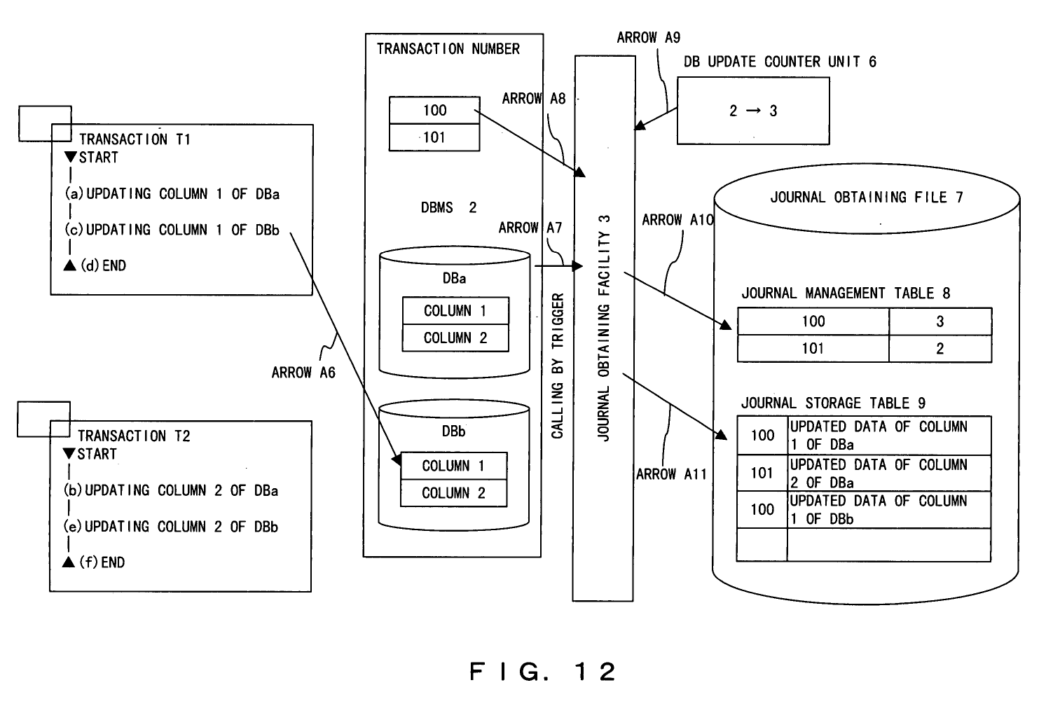

Then, the journal obtaining process to be performed when the updating process (c) in the transaction T1 is performed is described below by referring to FIG. 12. When the column 1 of the source database DBb is updated in the updating process (c) (arrow A6), the journal obtaining facility 3 is called by a trigger from the DBMS 2 (arrow A7). The journal obtaining facility 3 acquires the transaction number “100” of the transaction T1 from the DBMS 2 (arrow A8). Before the updating process (c), the updating process (b) in the transaction T2 is performed. In the journal obtaining process for the updating process (b), the count value of 2 of the DB update counter unit 6 is obtained. The journal obtaining facility 3 increments by 1 from the count value of 2 to 3 of the DB update counter unit 6, thereby obtaining the count value of 3. (arrow A9).

Since the journal management table 8 has already stored a record containing the transaction number “100”, the journal obtaining facility 3 updates the count value of 1 in the record into 3 (arrow A10). Furthermore, the journal obtaining facility 3 inserts the record containing the transaction number “100” and “updated data of the column 1 of the source database DBb” into the journal storage table 9 (arrow A11).

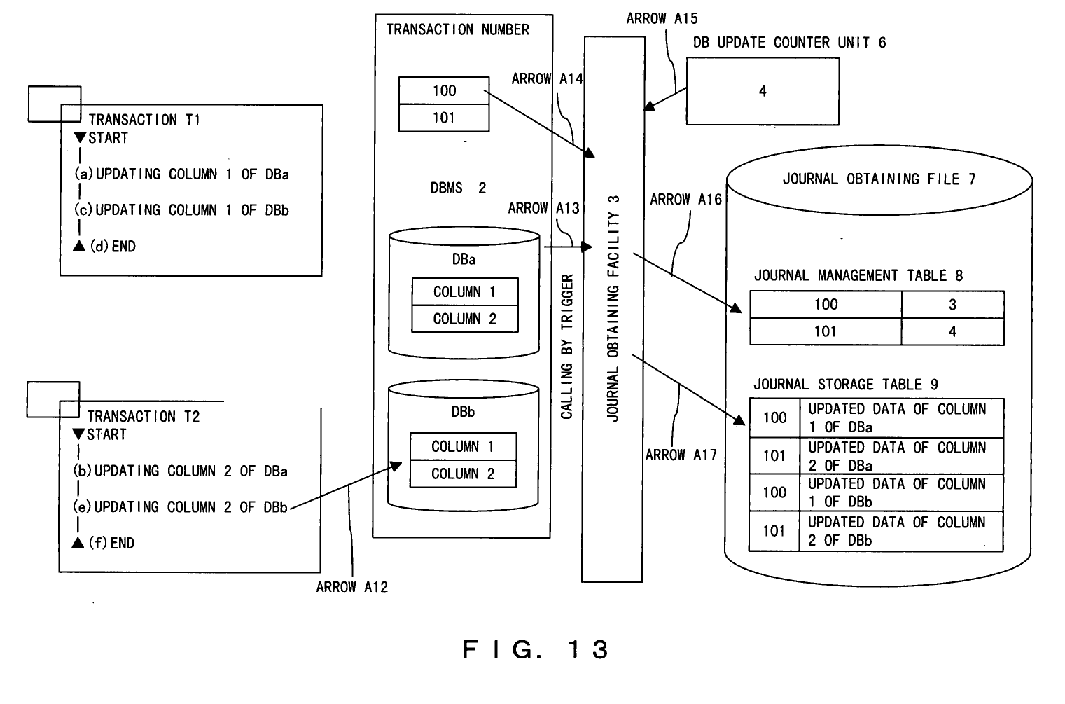

After the updating process (c), the transaction T1 terminates. Then, the updating process (e) in the transaction T2 is performed. Finally, by referring to FIG. 13, the journal obtaining process performed when the updating process (e) in the transaction T2 is performed is explained. When the column 2 of the source database DBb is updated by the updating process (e) (arrow A12), the journal obtaining facility 3 is called by a trigger from the DBMS 2 (arrow A13). The journal obtaining facility 3 acquires the transaction number “101” of the transaction T2 from the DBMS 2 (arrow A14). Furthermore, the journal obtaining facility 3 increments by 1 the count value of 3 of the DB update counter unit 6 into 4, and the count value of 4 is obtained (arrow A15).

Since the journal management table 8 has stored the record containing the transaction number “101”, the journal obtaining facility 3 updates the count value of 2 in the record into 4 (arrow A16). Furthermore, the journal obtaining facility 3 inserts the record containing the transaction number “101” and “updated data of the column 2 of the source database DBb” into the journal storage table 9 (arrow A17).

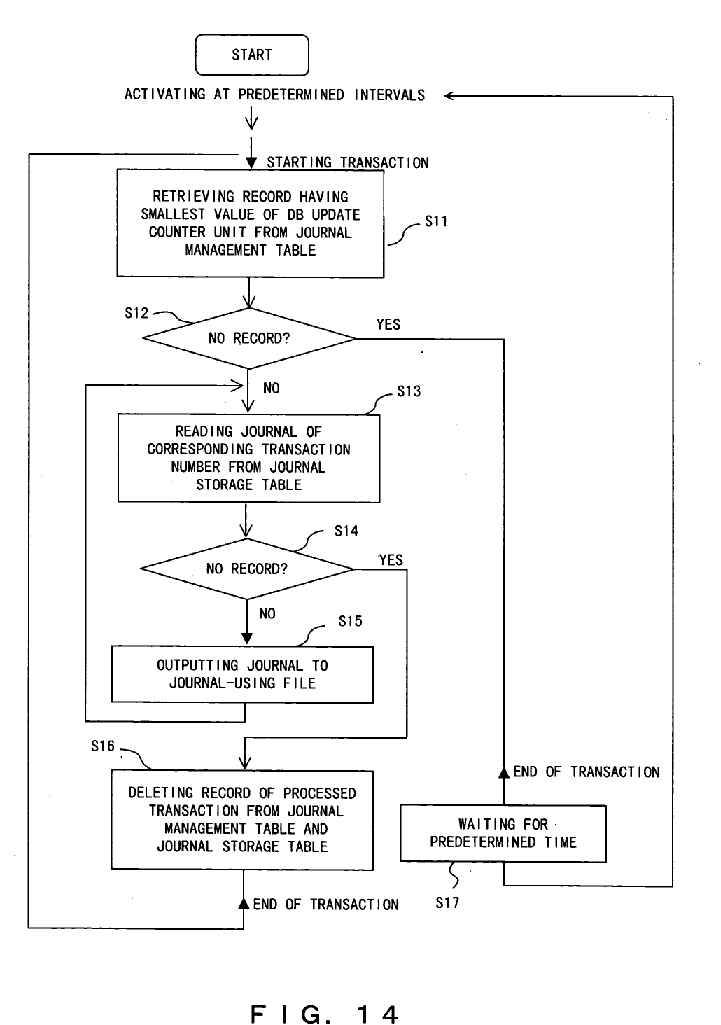

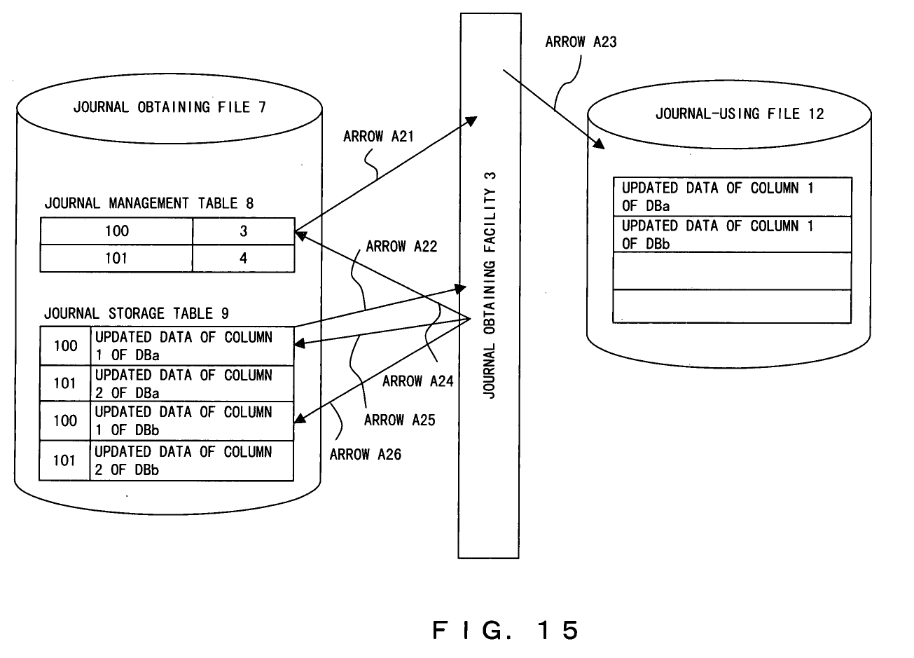

Thus, when a journal generated by the updating process during the transaction is obtained, a journal distributing process is performed. In the journal distributing process, the journal distribution facility 10 distributes a journal stored in the journal obtaining file 7 to the journal-using file 12. The journal distributing process is explained below by referring to FIGS. 14 and 15. FIG. 14 is a flowchart showing the journal distributing process. The process shown in FIG. 14 is performed at predetermined time intervals in principle. Obviously, the process can also be performed irregularly on the occasion of the maintenance, etc.

First, as shown in FIG. 14, when the journal distribution facility 10 is activated at predetermined intervals, a transaction of distributing a journal starts. First, the journal distribution unit 11 in the journal distribution facility 10 retrieves a record containing the smallest count value from the journal management table 8 (step S11), and determines whether or not the corresponding record is stored in the journal management table 8 (step S12). If there is no record in the journal management table 8 (NO in step S12), the transaction of distributing a journal is terminated, and control is passed to step S17. In step S17, the passage of a predetermined time is awaited.

When the corresponding record is stored in the journal management table 8 (YES in step S12), the journal distribution unit 11 obtains a journal from the record in the journal storage table 9 having the same transaction number as the record in the journal management table 8 (step S13). If the corresponding journal is stored in the journal storage table 9 (YES in step S14), then the journal distribution unit 11 reads the journal, and outputs it to the journal-using file 12 (step S15). If no corresponding journal is stored in the journal storage table 9 (NO in step S14), the process in step S15 is not performed, and control is passed to step S16.

In step S16, the journal distribution unit 11 deletes a record having the transaction number of a processed transaction from the journal management table 8 and the journal storage table 9, and control is returned to step S11.

Thus, the journal in the journal obtaining file 7 is distributed to the journal-using file 12. The journal written to the journal-using file 12 is written to the destination databases DB1 and DB2 by the transaction of reflecting the journal. As described above, the journal is distributed for each transaction on the journal obtaining side. Therefore, the journal is reflected for each transaction on the journal obtaining side.

The journal distributing process to be performed when the journal obtaining file 7 stores the data shown in FIG. 15 is practically explained below. The explanation is based on the same assumption as the explanation of the flow of the communications of a journal as shown in FIG. 9.

First, the journal distribution facility 10 obtains a record having the smallest count value of 3 from the journal management table 8 (arrow A21) The record contains the transaction number “100”. Therefore, the journal distribution facility 10 obtains a record containing the transaction number “100” (arrow A22), and writes the journal contained in the record to the journal-using file 12 (arrow A23). In the transaction T1 corresponding to the transaction number “100”, “updated data of the column 1 of source database DBa” and “updated data of the column 1 of the source database DBb” are generated in the updating processes (a) and (c) Therefore, in this case, the “updated data of the column 1 of source database DBa” and the “updated data of the column 1 of the source database DBb” are written to the journal-using file 12.

Finally, the journal distribution facility 10 deletes a record containing the transaction number “100” from the journal management table 8 and the journal storage table 9 (arrows A24, A25, and A26).

Described below is the second embodiment of the present invention. In the first embodiment, the case in which a notification that the process of a transaction has normally been completed is not transmitted from the DBMS 2 to the journal obtaining facility 3 is explained. In the second embodiment, the case in which a notification that a transaction has been committed is transmitted from the DBMS 2 to the journal obtaining facility 3 is explained below.

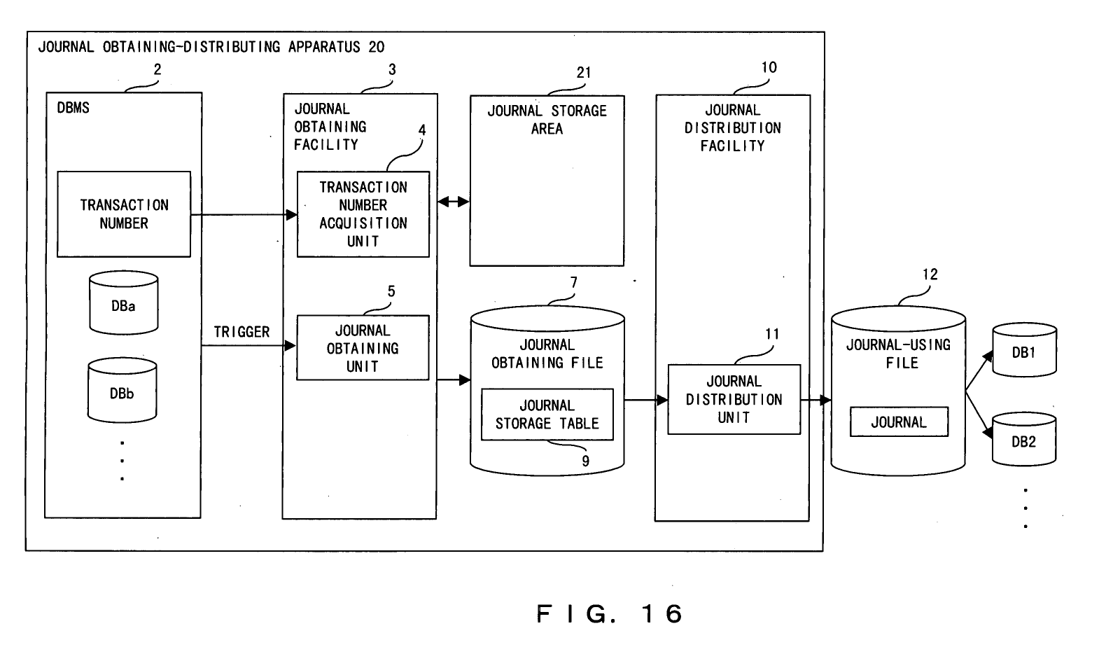

FIG. 16 shows the configuration of the journal obtaining-distributing apparatus according to the second embodiment of the present invention. As shown in FIG. 16, the configuration of a journal obtaining-distributing apparatus 20 according to the second embodiment is substantially the same as that of the journal obtaining-distributing apparatus 1 according to the first embodiment. The different point between them is that the journal obtaining-distributing apparatus 1 according to the first embodiment comprises the DB update counter unit 6 and the journal management table 8, but they are replaced with a journal storage area 21 in the journal obtaining-distributing apparatus 20 according to the second embodiment.

The operations of each unit forming part of the journal obtaining-distributing apparatus 20 according to the second embodiment are basically the same as those according to the first embodiment. Therefore, the different points between the apparatuses are described below.

The DBMS 2 calls the journal obtaining facility 3 by a trigger each time the source databases DBa and DBb are updated, and outputs a journal to the journal obtaining facility 3. Furthermore, the DBMS 2 calls the journal obtaining facility 3 by a trigger each time a transaction terminates, and receives as a response a notification of a storage area storing the journal relating to the completed transaction from the journal obtaining facility 3. The DBMS 2 inserts the journal in the storage area into the journal storage table 9.

When the journal obtaining unit 5 obtains a journal from the DBMS 2, the transaction number acquisition unit 4 acquires a transaction number from the DBMS 2, and sets the journal and the transaction number in the journal storage area 21.

Upon receipt of the notification of the completion of the transaction from the DBMS 2, the transaction number acquisition unit 4 acquires a transaction number from the DBMS 2, and notifies the DBMS 2 of the storage area corresponding to the transaction number in the journal storage area 21.

The journal distribution facility 10 is activated at predetermined time intervals in principle. When the journal distribution facility 10 is activated, it distributes a journal by outputting a journal stored in the journal storage table 9 to the journal-using file 12.

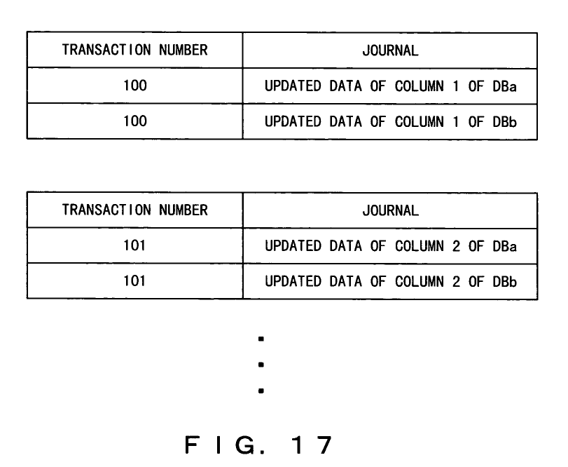

The journal storage area 21 stores a journal for each transaction number. The journal storage area 21 is arranged in, for example, the memory of a computer. FIG. 17 shows an example of the data structure of the journal storage area 21. As shown in FIG. 17, the journal storage area 21 has a storage area for storing a journal for each transaction number.

Described below is the configuration of the system to which the journal obtaining-distributing apparatus according to the second embodiment of the present invention is applied. The system comprises a computers C1 and C2 connected to each other over a network like the journal obtaining-distributing apparatus shown in FIG. 8. The configuration of the computer C1 is somewhat different between the first and second embodiments. In the second embodiment, the computer C1 comprises the source databases DBa and DBb, the DBMS 2 for managing the source databases, the journal obtaining facility 3, the journal obtaining file 7, the journal distribution facility 10, and the journal storage area 21. The configuration of the computer C2 according to the second embodiment is the same as that according to the first embodiment.

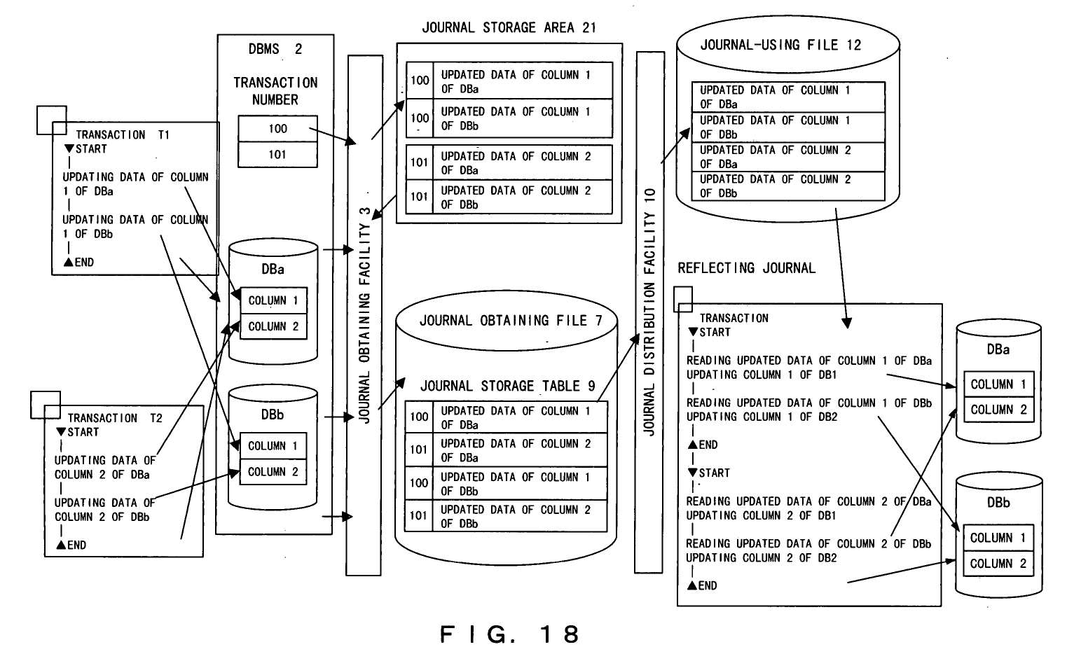

Described below is the procedure of the journal obtaining-distributing process according to the second embodiment. First, the outline of the flow of communicating a journal in the journal obtaining-distributing system is described by referring to FIG. 18. In the explanation below, as in the first embodiment, it is assumed that the columns 1 of the source databases DBa and DBb are updated in the transaction T1, and the columns 2 of the source databases DBa and DBb are updated in the transaction T2.

In the system according to the second embodiment, the DBMS 2 calls the journal obtaining facility 3 by a trigger each time a database is updated by the processes (a), (b), (c), and (e), and outputs a journal to the journal obtaining facility 3. The journal obtaining facility 3 obtains a journal and a transaction number from the DBMS 2, acquires a storage area corresponding to the obtained transaction number in the journal storage area 21, and writes the obtained journal and transaction number in the storage area. For example, when the column 1 of the source database DBa is updated in the updating process (a) of the transaction T1, the journal obtaining facility 3 obtains the “updated database of the column 1 of DBa” and the transaction number “100” of the transaction T1, and writes the “updated database of the column 1 of DBa” and the transaction number “100” of the transaction T1 to the journal storage area 21. The similar processes are performed in the updating processes (b), (c), and (e).

The DBMS 2 calls the journal obtaining facility 3 by a trigger each time a transaction terminates in the processes (d) and (f). For example, when the transaction T1 terminates in the process (d), the journal obtaining facility 3 obtains the transaction number “100” of the transaction T1 from the DBMS 2, and notifies the DBMS 2 of the storage area corresponding to the transaction number “100” in the journal storage area 21. At the notification, the DBMS 2 reads all journals assigned the transaction number “100” from the journal storage area 21, and inserts them into the journal storage table 9. Thus, all journals relating to the transaction T1 are written to the journal storage table 9. In the process (f), the similar process is performed when the transaction T2 terminates.

The journal distribution facility 10 is activated at predetermined time intervals in principle. When the journal distribution facility 10 is activated, it distributes a journal by outputting a journal stored in the journal storage table 9 to the journal-using file 12. As shown in FIG. 18, journals are written to the journal storage table 9 for each transaction on the journal obtaining side. Therefore, when the journals are sequentially distributed to the journal-using file 12 in the order in which they are stored in the journal storage table 9, the journals are distributed for each transaction on the journal obtaining side. Since a transaction reflecting a journal is common to the first and second embodiments of the present invention, the explanation is omitted here.

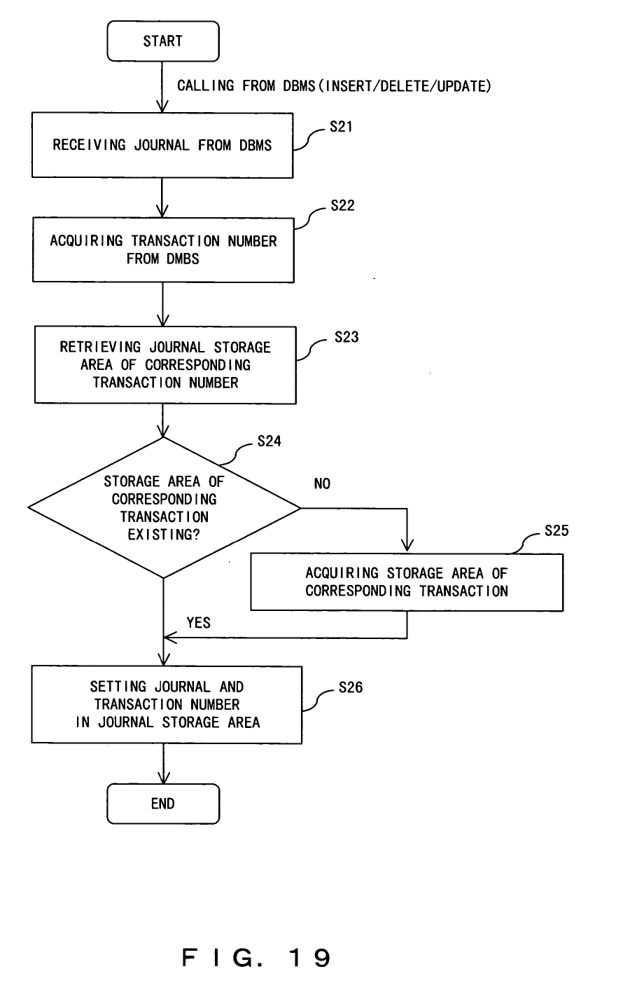

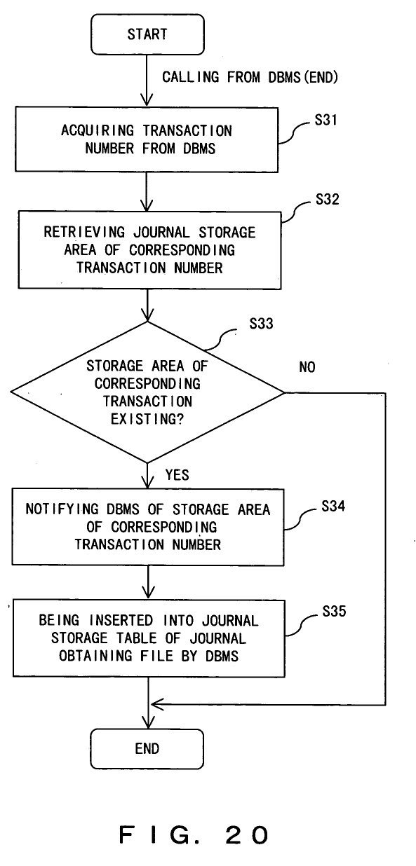

The journal obtaining-distributing process according to the second embodiment of the present invention is described below in detail by referring to FIGS. 19 through 21. First, the journal obtaining process is explained by referring to FIGS. 19 and 20. FIG. 19 is a flowchart of the journal obtaining process performed when a database is updated (data is changed, deleted, and added). The process shown in FIG. 19 is performed each time the journal obtaining facility 3 is called by a trigger from the DBMS 2.

As shown in FIG. 19, when the journal obtaining facility 3 is first called by a trigger from the DBMS 2, the journal obtaining unit 5 receives a journal output by the update of a database (step S21). Then, the transaction number acquisition unit 4 acquires a transaction number from the DBMS 2 (step S22). The transaction number acquisition unit 4 retrieves a storage area corresponding to the acquired transaction number from the journal storage area 21 (step S23), and determines whether or not the storage area corresponding to the transaction number exists in the journal storage area 21 (step S24).

When the corresponding storage area exists in the journal storage area 21 (YES in step S24), the transaction number acquisition unit 4 sets the journal obtained in step S21 and the transaction number acquired in step S22 in the storage area (step S26), thereby terminating the process. When the corresponding storage area does not exist in the journal storage area 21 (NO in step S24), the transaction number acquisition unit 4 acquires the storage area corresponding to the transaction number in the journal storage area 21 (step S25), and then the process in step S26 is performed, thereby terminating the process.

FIG. 20 is a flowchart of the journal obtaining process performed when a transaction terminates. The process shown in FIG. 20 is also performed each time the journal obtaining facility 3 is called by a trigger from the DBMS 2.

As shown in FIG. 20, when the journal obtaining facility 3 is called by a trigger from the DBMS 2, the transaction number acquisition unit 4 acquires the transaction number from the DBMS 2 (step S31). Then, the transaction number acquisition unit 4 retrieves the storage area corresponding to the acquired transaction number from the journal storage area 21 (step S32), and determines whether or not the storage area corresponding to the transaction number exists in the journal storage area 21 (step S33).

When the corresponding storage area exists in the journal storage area 21 (YES in step S33), the transaction number acquisition unit 4 notifies the DBMS 2 of the storage area (step S34). The DBMS 2 acquires the journal corresponding to the transaction number from the storage area specified in the notification, and inserts the transaction number and the obtained journal into the journal storage table 9 (step S35). Then, the process terminates. On the other hand, if the corresponding storage area does not exist in the journal storage area 21 (NO in step S33), the processes in steps S34 and S35 are not performed, and the current process terminates.

Thus, the journal obtaining facility 3 obtains a journal for each transaction on the journal obtaining side.

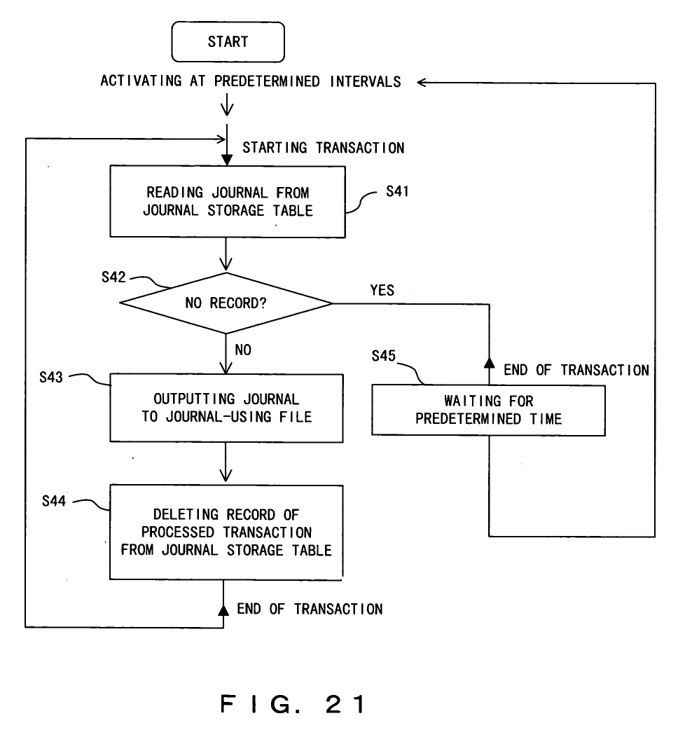

The journal distributing process is described below by referring to FIG. 21. FIG. 21 is a flowchart of the journal distributing process . The process shown in FIG. 21 is performed at predetermined time intervals in principle.

First, as shown in FIG. 21, when the journal distribution facility 10 is activated at predetermined intervals, a transaction of distributing a journal starts. First, the journal distribution unit 11 in the journal distribution facility 10 sequentially reads journals from the journal storage table 9 in the order in which they were stored (step S41). When there are no records to be read (NO in step S42), control is passed to step S45. In step S45, the passage of a predetermined time is awaited.

If a record can be read (YES in step S42), the journal distribution unit 11 outputs a journal in the record to the journal-using file 12 (step S43). Then, the journal distribution unit 11 deletes the read record from the journal storage table 9 (step S44), and control is returned to step S41.

Thus, the journal in the journal obtaining file 7 is distributed to the journal-using file 12. From the explanation above, a journal is distributed for each transaction on the journal obtaining side also according to the second embodiment. Since a journal is distributed for each transaction on the journal obtaining side, the journal is reflected for each transaction on the journal obtaining side.

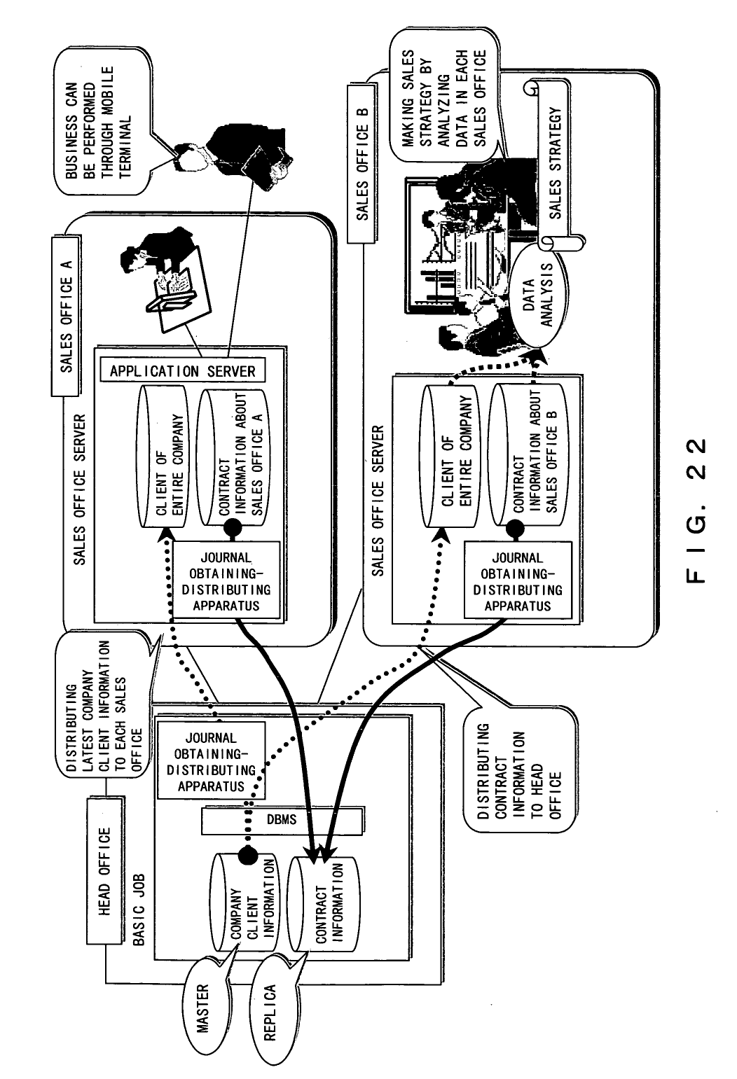

FIG. 22 shows an example of an application of the journal obtaining-distributing apparatus. In FIG. 22, the journal obtaining-distributing apparatus is used in a server provided in a head office and each sales office managed by the head office. A server (hereinafter referred to as a sales office server) provided for each sales office has a company client information database storing the information about the clients of the entire company, a sales office contract information database storing the contract information for each sales office, a DBMS (omitted in the attached drawings), and a journal obtaining-distributing apparatus. The journal obtaining-distributing apparatus in a sales office server uses a sales office contract information database as a source database, and a company contract information database in the server provided for the head office (hereinafter referred to as a head office server) as a destination database. Therefore, when a sales office contract information database in each sales office server is updated, the journal generated in the updating process is distributed to the company contract information database in the head office server. Thus, the head office can constantly obtain the latest contract information of each sales office.

On the other hand, the head office server is provided with a company client information database, a company contract information database storing the contract information about all sales offices, a DBMS, and a journal obtaining-distributing apparatus. The journal obtaining-distributing apparatus in the head office server uses the company client information database in the head office server as a source database, and the company client information databases in the sales office servers as destination databases. Therefore, when the company client information database in the head office server is updated, the journal generated in the updating process is distributed to the company client information database in each sales office server. Thus, each sales office can obtain the latest client information. Each sales office analyzes the up-to-date sales record according to the latest client information and contract, and can make a sales strategy for the future.

Each sales office server such as a sales office A, etc. shown in FIG. 22, each sales office server can have the function as an application server which communicates information with each type of terminal.

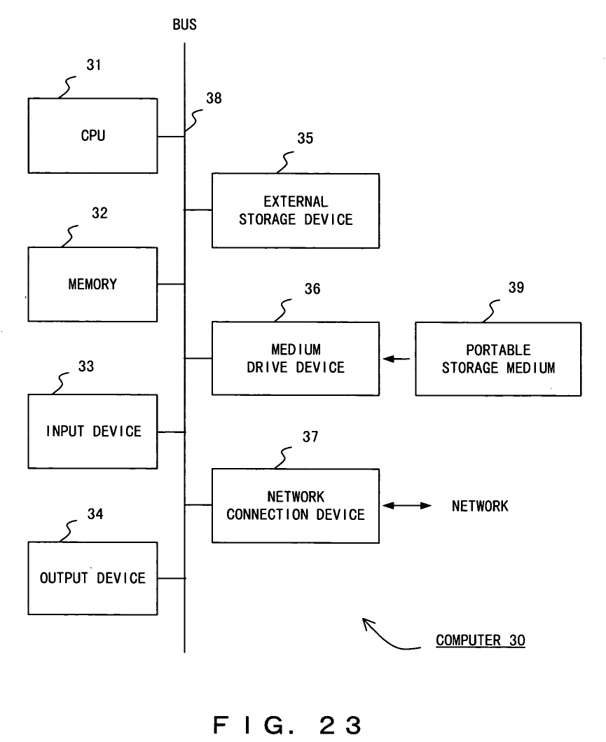

The above-mentioned journal obtaining-distributing apparatuses 1 and 20 can be configured using a computer. FIG. 23 shows the configuration of a computer. As shown in FIG. 23, a computer 30 comprises a CPU 31, a memory 32, an input device 33, an output device 34, an external storage device 35, a medium drive device 36, and a network connection device 37, which are interconnected through a bus 38.

The memory 32 includes, for example, ROM (read-only memory), RAM (random access memory), etc., and stores a program and data for use in a process. When the journal obtaining-distributing apparatus 1 according to the first embodiment is configured using a computer, the memory 32 stores a control program used to direct the computer to perform the process performed by the journal obtaining facility 3, the DB update counter unit 6, and the journal distribution facility 10 in a specific program code segment. When the journal obtaining-distributing apparatus 20 according to the second embodiment is configured using a computer, the memory 32 stores a control program used to direct the computer to perform the process performed by the journal obtaining facility 3 and the journal distribution facility 10 in a specific program code segment, and realizes the journal storage area 21.

The CPU 31 performs a necessary process by executing the above-mentioned control program using the memory 32.

The input device 33 can be, for example, a keyboard, a pointing device, a touch panel, etc., and is used in inputting an instruction and information from a user. The output device 34 can be, for example, a display, a printer, etc., and is used in issuing an inquiry to a user, outputting a process result, etc.

The external storage device 35 can be, for example, a magnetic disk device, an optical disk device, a magneto-optical disk device, etc. The external storage device 35 realizes the journal obtaining file 7 provided for the journal obtaining-distributing apparatus 1 or 20, and the journal-using file 12 provided for the device which is a destination of a journal. The above-mentioned control program can be stored in the external storage device 35, and can be loaded into the memory 32 as necessary for use.

The medium drive device 36 drives a portable storage medium 39, and accesses the recorded contents of the portable storage medium 39. The portable storage medium 39 can be a computer-readable storage medium such as a memory card, a memory stick, a flexible disk, CD-ROM (compact disc read only memory), an optical disk, a magneto-optical disk, a DVD (digital versatile disk), etc. The portable storage medium 39 can store the above-mentioned control program, load it into the memory 32 of the computer as necessary for use.

The network connection device 37 communicates with an external device over any network (circuit) such as a LAN, a WAN, etc., and converts data required in the communications. As necessary, the above-mentioned program can be received from an external device, and loaded into the memory 32 of the computer for use.

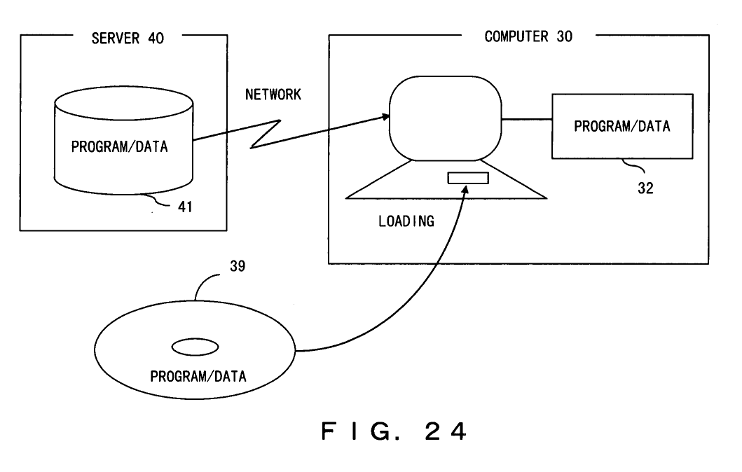

FIG. 24 shows loading a program into the computer shown in FIG. 23. A program used to direct the computer 30 to realize the center server C can be loaded into the computer as described below.

First, the above-mentioned program is stored in advance in the computer-readable portable storage medium 39. As shown in FIG. 24, the program can be read by the computer 30 from the portable storage medium 39, and temporarily stored in the memory 32 or the external storage device 35 of the computer 30, and the stored program can be read by the CPU 31 of the computer.

Furthermore, a program can be downloaded over a network from a DB 41 of a server 40 for providing a program and data. In this case, for example, the server 40 converts program data representing a program into a program data signal, a modem modulates the converted program data signal into a transmission signal, and the obtained transmission signal is output to a network. The computer 30 which receives the program demodulates the received transmission signal using the modem, obtains a program data signal, and converts the obtained program data signal, thereby obtaining program data. When the network which connects a transmitting computer to a receiving computer is a digital circuit, a program data signal can also be communicated.

As described above, the embodiments and the variations of the present invention are explained, but the present invention is not limited to the above-mentioned embodiments or variations, and many other variations can be realized.

As mentioned above, according to the present invention, when a plurality of source database are replicated, the replication can be performed for each transaction, thereby maintaining the consistency between databases while avoiding a complicated logic process or the delay of processing time of a transaction.

What is claimed is:

1. A computer program used to direct a computer to obtain a journal as an update result from a source database, and distribute the journal to a destination database, comprising:
obtaining the journal from the source database;
obtaining transaction identification information for identifying a transaction of updating the source database when the journal is obtained;
counting a number of times the source database is updated;
rearranging the journal according to a count value and the transaction identification information before distributing a journal; and
distributing the rearranged journal to the destination database for each transaction of updating the source database according to the transaction identification information.

2. The computer program according to claim 1, further comprising:
associating the count value with the transaction identification information obtained when the count value is obtained, and storing the count value and the transaction identification information in a journal management information storage unit;
associating the journal with the transaction identification information obtained when the journal is obtained, and storing the journal and the transaction identification information in a journal storage unit;
at a predetermined timing, obtaining transaction identification information associated with a smallest count value from the journal management information storage unit; and
selecting a journal corresponding to the transaction identification information obtained from the journal management information storage unit in journals stored in the journal storage unit as a journal to be distributed.

3. A journal obtaining-distributing method for use by a computer obtaining a journal as a update result from a source database, and distributing the journal to a destination database, comprising:
obtaining the journal from the source database;
obtaining transaction identification information for identifying a transaction of updating the source database when the journal is obtained;
counting a number of times the source database is updated;
rearranging the journal according to a count value and the transaction identification information before distributing a journal; and
distributing the rearranged journal to the destination database for each transaction of updating the source database according to the transaction identification information.

4. The method according to claim 3, further comprising:
associating the count value with the transaction identification information obtained when the count value is obtained, and storing the count value and the transaction identification information in a journal management information storage unit;
associating the journal with the transaction identification information obtained when the journal is obtained, and storing the journal and the transaction identification information in a journal storage unit;
at a predetermined timing, obtaining transaction identification information associated with a smallest count value from the journal management information storage unit; and
selecting a journal corresponding to the transaction identification information obtained from the journal management information storage unit in journals stored in the journal storage unit as a journal to be distributed.

5. A journal obtaining-distributing apparatus which obtains a journal as an update result from a source database, and distributes the journal to a destination database, comprising:
a journal obtaining unit obtaining the journal from the source database;
an identification information acquisition unit obtaining transaction identification information for identifying a transaction of updating the source database when the journal is obtained;
a counter counting a number of times the source database is updated;
a journal rearrangement unit rearranging the journal according to the count value and the transaction identification information before distributing a journal; and
a journal distribution unit distributing the obtained journal to the destination database for each transaction of updating the source database.
